(19) United States
(12) Patent Application Publication
(10) Pub. No.: US 2009/0284748 A1
(43) Pub. Date: Nov. 19, 2009

(54) Speckle Noise Reduction in Coherent Imaging Systems

(76) Inventors: Paul Melman, Newton, MA (US); Stephen Cohen, Chestnut Hill, MA (US); Shmuel Halevi, Chestnut Hill, MA (US)

Correspondence Address: Stephen Cohen;c/o Newton Photonics, 104 Manet Road, Chestnut Hill, MA, 02467, US

(21) Appl. No.: 12/030,538

(22) Filed: Feb. 13, 2008

Related U.S. Application Data
(60) Provisional application No. 60/889,625, filed on Feb. 13, 2007.

(51) Int. Cl. G01B 9/02; H01S 3/00

(52) U.S. Cl. 356/479; 372/33

(57) ABSTRACT

A method for reducing speckle noise in a coherent imaging system includes applying a time varying phase gradient across a sample beam of the system to convert spatial distortion to temporal noise, recording a plurality of measurements of the sample beam, and averaging the plurality of measurements to reduce the temporal noise. Another method includes acquiring a plurality of sample scans while modulating a numerical aperture of a sample beam, and concatenating the plurality of scans such that speckle noise is decorrelated from adjacent scans of the plurality of scans. An apparatus for reducing speckle noise includes an optical element for applying a time varying phase gradient across a sample beam of the system to convert spatial distortion to temporal noise, a detector for recording a plurality of measurements of the sample beam, and circuitry for averaging the plurality of measurements to reduce the temporal noise.

This application claims the benefit of U.S. Provisional Application No. 60/889,625 filed 13 Feb. 2007, which is incorporated by reference herein in its entirety.

### BACKGROUND

Speckle noise is a spurious and random spatial intensity variation caused by coherent interference of randomly phased waves arriving at an image plane. The randomness of the phases is caused by scattering of the illuminating beam. Examples of systems affected by speckle noise include optical coherence tomography (OCT), ultrasound imaging, low coherence interferometry, and synthetic aperture radar.

Speckle noise significantly limits the information content provided by coherent systems. Speckles greatly reduce the contrast between regions with small, intrinsic reflectance differences and limit the effective spatial resolution. For example, subtle changes in the scattering properties of tissue have been associated with transitions from normal to diseased states making speckle reduction critical in many medical applications.

Speckle noise is a stationary pattern that modulates and distorts the image. It is not removable by signal averaging over multiple samples. Spatial filtering within a single sample has been used previously but invariably has led to reduced resolution, contrast and dynamic range. Known spatial filtering methods include median filtering, phase-domain processing, frequency compounding, wavelet-based filtering, and I-divergence regularization.

Speckle noise in coherently generated images, i.e. images obtained through illumination by coherent waves. It appears as a time independent, spatial random modulation of the image. It cannot be easily removed by signal averaging or filtering without significant loss of spatial resolution. Previous solutions for reducing speckle noise include recording multiple images over a range of wavelengths, angles of illumination, or image positions. Other solutions include post processing of the image data using a variety of numerical techniques. These approaches generally cause either loss of spatial resolution, loss of contrast, or lead to high system complexity and cost.

It would be advantageous to provide speckle noise reduction in a manner that minimizes spatial resolution loss and contrast loss without significantly increasing system complexity and cost.

### SUMMARY

In one embodiment, a method for reducing speckle noise in a coherent imaging system includes applying a time varying phase gradient across a sample beam of the system to convert spatial distortion to temporal noise, recording a plurality of measurements of the sample beam, and averaging the plurality of measurements to reduce the temporal noise.

In another embodiment, an apparatus for reducing speckle noise in a coherent imaging system includes an optical element for applying a time varying phase gradient across a sample beam of the system to convert spatial distortion to temporal noise, a detector for recording a plurality of measurements of the sample beam, and circuitry for averaging the plurality of measurements to reduce the temporal noise.

In still another embodiment, a method for reducing speckle noise in a coherent imaging system includes acquiring a plurality of sample scans while modulating the numerical aperture of a sample beam, and concatenating the plurality of scans such that speckle noise is decorrelated from the adjacent scans. of the plurality of scans.

### BRIEF DESCRIPTION OF THE DRAWINGS

The foregoing aspects and other features of the presently disclosed embodiments are explained in the following description, taken in connection with the accompanying drawings, wherein:

FIG. 1 depicts an exemplary coherent system for imaging a scattering surface according to the disclosed embodiments;

FIG. 2 shows an exemplary system according to the disclosed embodiments that includes a free space interferometer;

FIG. 3 shows another exemplary free space interferometer embodiment that that utilizes both image plane and object plane averaging;

FIG. 4 shows yet another exemplary free space interferometer embodiment that that utilizes an averaging scheme;

FIG. 5 shows an exemplary fiber based interferometric system according to the disclosed embodiments;

FIG. 6 shows another exemplary embodiment that utilizes a moving lens to convert stationary speckle noise to temporal noise;

FIGS. 7 and 8 show additional exemplary embodiments of sample arms for use with the fiber based interferometric embodiments described herein;

FIG. 9 shows an OCT system that dithers a lens to decorrelate a speckle pattern; and

FIG. 10 shows a system for decorrelating speckle noise by modulating a focal length of a focusing lens.

### DETAILED DESCRIPTION

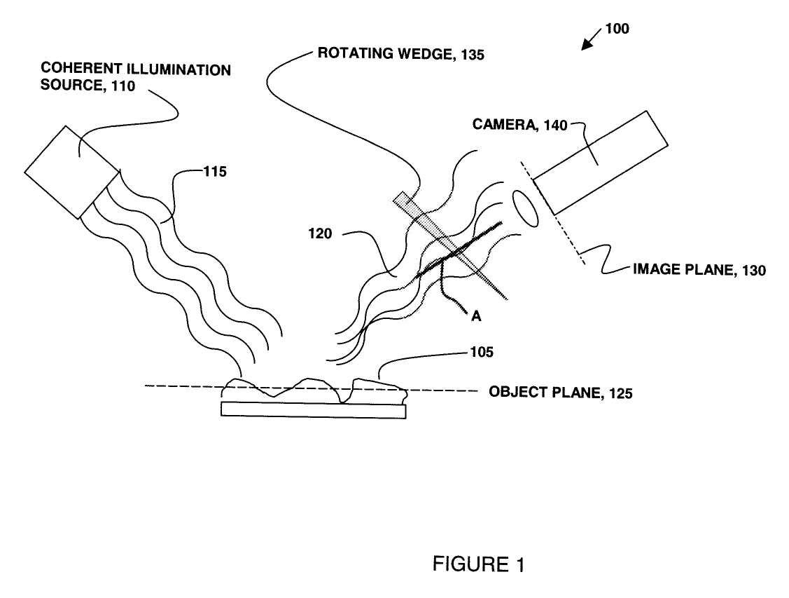

FIG. 1 shows a block diagram of a system 100 that demonstrates the principles of the disclosed embodiments. Although the presently disclosed embodiments will be described with reference to the drawings, it should be understood that they may be embodied in many alternate forms. It should also be understood that any suitable size, shape, or type of elements or materials could be used.

Generally, the techniques and structures of the present embodiments may take advantage of the difference between random, phase-induced speckle noise and the reflectance-induced intensity changes caused by an imaged or measured object. Some of the disclosed embodiments generally operate to convert stationary patterns of spatial noise, also referred to as speckle noise, to a temporal noise which can be subsequently removed by multi-sample averaging. Other embodiments include reducing speckle noise by decorrelation of the speckle pattern while leaving the image pattern unaffected. Decorrelation may be accomplished by modulating the numerical aperture of a sample illuminating or a sample reflected beam or both. The resulting temporal noise may then be filtered or averaged to reduce speckle noise. In other embodiments, modulating a numerical aperture may generally randomize the effect of speckle from one axial scan to another across an image. The disclosed embodiments include techniques and structures for reducing speckle noise by application of a time varying phase gradient across a beam of an optical system. The spatial phase modulation makes the phase relations between the different parts of the beam time dependent, thus converting the spatial distortion to temporal noise. Averaging over multiple samples results in an advantageous reduction in speckle noise. The phase gradient can be added to the illuminating beam, be it electromagnetic or acoustic in nature, before it scatters off the object (object plane averaging), after scattering (image plane averaging) or both. Non-limiting exemplary applications of the disclosed embodiments include coherent non-interferometric imaging systems, free space interferometric systems, fiber-based interferometric systems, and other coherent imaging and measurement systems.

FIG. 1 depicts a coherent system 100 for imaging a scattering surface 105. A source of coherent illumination 110 may emit a sample illuminating beam 115 which may illuminate surface 105 in object plane 120. Waves in an imaging beam 125 reflected from the surface 105 may exhibit a spatial phase variation which may produce a stationary speckle noise pattern, also described as pebble like noise, in image plane 130.

A transparent wedge 135, shown in this embodiment in an image side of system 100, may generate a phase gradient within reflected sample beam 120. Transparent wedge 135 may be rotated about an axis A of imaging beam 120, resulting in the speckle noise pattern moving across image plane 130, thus converting the stationary speckle noise pattern to temporal noise. Frames of image plane 130 may be captured by camera 140. Frame averaging performed by camera 140 or by another device may remove the temporal noise without affecting image resolution.

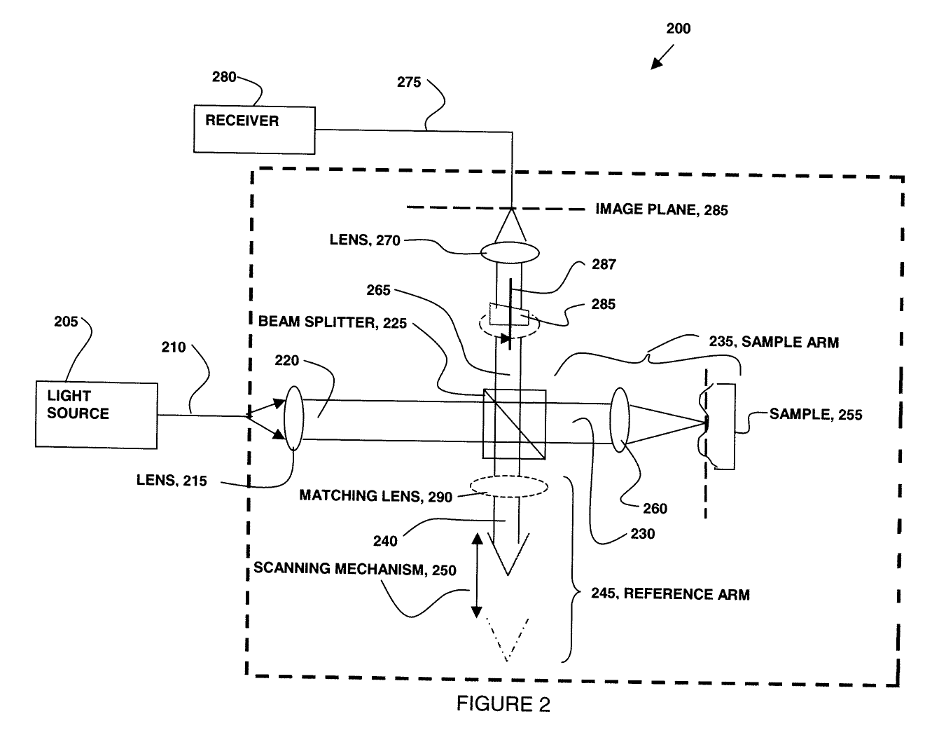

FIG. 2 shows an embodiment 200 that includes a free space interferometer, for example, an optical coherence tomography (OCT) system, that utilizes image plane averaging. A broadband light source 205, for example, an LED, pulsed laser or wavelength tunable laser, may provide light through a delivery device 210, for example, an optical fiber. A collimating lens 215 receives the light and may emit a parallel beam 220. A beam splitter 225 may separate the parallel beam 220 into a sample illuminating beam 230 along a sample arm 235 and a reference beam 240 along a reference arm 245. The reference beam 240 may be reflected upon itself by a scanning mechanism 250, for example, a moving mirror or any other suitable scanning mechanism. The sample illuminating beam 230 may be focused on a sample 255 by lens 260. Back scattered light from the sample 255, also referred to as reflected sample beam 230, may be collected and collimated by the lens 260 and combined with the reference beam 240 at the beam splitter 225. The combined beam 265 may be directed toward a focusing lens 270, collected by a receiving fiber 275 and detected by a receiver 280.

For speckle reduction, a rotating element 285 in the combined beam 265 adds a phase gradient to the combined beam. The rotating element 285 may be rotated around an axis 287 of combined beam 265 by any suitable mechanism, including for example, a motor, mechanical drive, electrical drive, magnetic drive, or any other suitable mechanism for rotating the wedge 285. Rotation of the element 285 causes a time dependent modulation of the phase, effectively converting the stationary image distortion in the form of speckle noise to a time dependent variation which can be filtered in the time or frequency domains by the receiver 280 or some other device. If the sample 255 is a random medium, for example, tissue, the focused spot spreads into an extended light distribution. The receiving fiber 275 then samples this distribution. In this embodiment, the rotating element 285 is shown as a transparent wedge. In other embodiments, the rotating element may include a rotating arbitrary index profile plate, or any other element suitable for providing a time varying phase gradient across a beam.

To maximize interference in the sample image forming beam 265 the profiles of the sample beam 230 and the reference beam 240 may be matched in the image plane 285 by using, for example, a matching lens 290 in the reference arm 245.

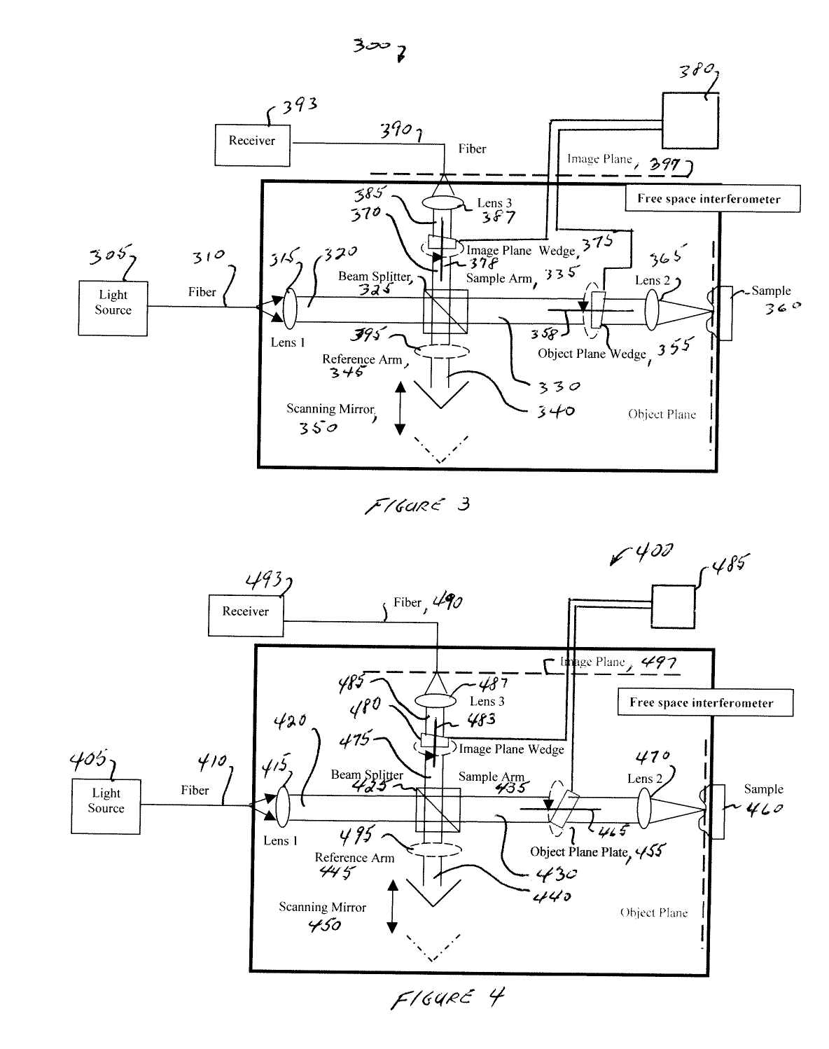

FIG. 3 shows another free space interferometer embodiment 300 that that utilizes both image plane and object plane averaging. A broadband light source 305, similar to broadband light source 205 may provide light through a delivery device 310, similar to delivery device 210. Collimating lens 315 may receive the light and emit a parallel beam 320 toward beam splitter 325. Beam splitter 325 may separate parallel beam 320 into a sample illuminating beam 330 along sample arm 335 and a reference beam 340 along reference arm 345. The reference beam 340 is generally reflected upon itself by scanning mechanism 350, which may include for example, a moving mirror or other suitable scanning mechanism.

In this embodiment, a first rotating transparent wedge 355 in the sample beam 330 adds a phase gradient to the sample beam which is focused on sample 360 by lens 365. Back scattered light from sample 360, also referred to as a reflected sample beam 330, may be collected and collimated by lens 365 and passed back through first rotating wedge 355 to beam splitter 325 for combination with reference beam 340. The combined beam 370 may be directed toward a second rotating transparent wedge 375 which adds an additional phase gradient to the combined beam. The first and second rotating transparent wedges 355, 375 may be rotated around axes 358, 378, respectively, by any suitable mechanism, similar to rotating wedge 285. In addition, a relative phase of rotation of wedges 355, 375 may be controlled, for example, using a controller 380 to optimize speckle reduction. Similar to the embodiment of FIG. 2, rotation of transparent wedges 355, 375 causes a time dependent modulation of the speckle noise, thus converting the stationary speckle noise to temporal noise which may be filtered. The modulated beam 385 may be directed toward focusing lens 387, collected by receiving fiber 390 and detected by a receiver 393. The receiver 397 may produce a signal which may be filtered by the receiver or some other device.

While this embodiment utilizes rotating transparent wedges 355, 375, it should be understood that other elements suitable for providing a time varying phase gradient across a beam may also be used. For example, the disclosed embodiments may also include one or more rotating arbitrary index profile plates for providing the time varying phase gradient in place of one or both of the transparent wedges 355, 375.

Similar to the embodiment of FIG. 2, a matching lens 395 in reference arm 345 may be used to match the profiles of the sample beam 330 and the reference beam 340 in the image plane 397 to maximize interference in the combined beam 370 and the modulated combined beam 385.

FIG. 4 shows yet another free space interferometer embodiment 400 that that utilizes an averaging scheme. A broadband light source 405 may provide light through a delivery device 410 to a collimating lens 415 that may emit a parallel beam 420 toward a beam splitter 425. The beam splitter 425 may separate parallel beam 420 into a sample illuminating beam 430 along a sample arm 435 and a reference beam 440 along a reference arm 445, where the reference beam 440 may be reflected upon itself by a scanning mechanism 450, similar to scanning mechanisms 250, 350. Similar to other embodiments, a matching lens 495 in reference arm 445 may be used to match the profiles of the sample beam 430 and the reference beam 440 in an image plane 497 to maximize interference.

This embodiment includes a tilted parallel plate 455 interposed in the sample beam between the beam splitter 425 and the sample 460. The tilted parallel plate 455 may be oriented at an angle with respect to an axis 465 of the sample beam 430 and may rotate around axis 465. The tilted parallel plate 455 causes beam displacement but no angular deflection, and thus does not affect image resolution. Continuous rotation of the plate 455 allows for averaging over an area of sample 460.

Light back scattered from sample 460, referred to as a reflected sample beam 430 may be collected and collimated by lens 470 and directed to beam splitter 425 where the sample beam 430 and the reference beam 440 are combined. The combined beam 475, or sample image forming beam may be directed toward a rotating transparent wedge 480 which adds a phase gradient to the combined beam, similar to the embodiment of FIG. 2. The rotating transparent wedge 480 may be rotated around an axis 483 of the combined beam by any suitable mechanism, similar to rotating wedge 285. A controller 485 may be used to control both, the rotation of the tilted parallel plate 455 and the rotation of the transparent wedge 480. Rotation of the transparent wedge 480 produces a time dependent modulation of the speckle noise, thus converting the stationary speckle noise to temporal noise. The modulated beam 485 may be directed toward a focusing lens 487, collected by a receiving fiber 490 and detected by a receiver 493. Filtering, averaging or time integration of the resulting signal, either individually or in combination, may be performed by the receiver 497 or some other device.

The exemplary embodiments described with respect to FIGS. 2-4 may be further extended to include two tilted parallel plates, one in the sample and reference beam, respectively, and to include the case where the parallel plates are positioned at a focal plane of an intermediate lens i.e. lens located between the fiber collimator or fiber focuser lens and the lens which focuses light on the sample under test. Other permutations of the wedge and parallel plate can be used in speckle reduction and the desired combination selected according to the specific application. As described above, any type or combination of rotating elements may be used provided they are suitable for providing a time varying phase gradient across a beam.

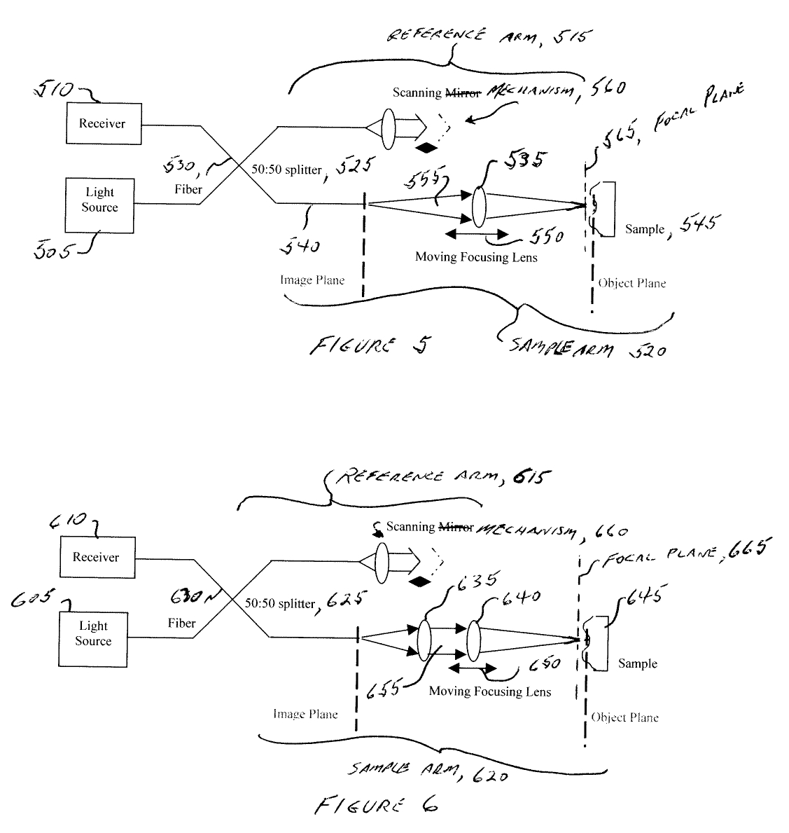

In FIG. 5, an embodiment that includes a fiber based interferometric system utilizes a moving lens to convert stationary speckle noise to temporal noise. FIG. 5 shows an OCT system 500, with a broad band light source 505, a receiver 510, a reference arm 515, a sample arm 520, and a 50:50 splitter 525 at a connection among the broad band light source 505, receiver 510, reference arm 515, and sample arm 520. The reference arm 515 includes a scanning mechanism 560 similar to scanning mechanisms 250, 350, 450. A fiber path 530 connects the components 505, 510, 515, 520 of the OCT system 500.

The sample arm 520 of this embodiment includes a movable focusing lens 535 positioned between a sample portion 540 of the fiber path and the sample 545. The focusing lens 535 may be transported along an axis 550 parallel to a sample illumination beam 555 emitted from the sample portion 540 by any suitable mechanism, including for example, a motor, mechanical drive, electrical drive, magnetic drive, or any other suitable mechanism for transporting the focusing lens 535 along the axis 550.

For a given position of the scanning mechanism 560, an axial distance at which the scattered light generates the OCT signal is independent of the axial position of focusing lens 535. However the light collected by the focusing lens 535 is focused back into the sample portion 540 of the fiber path. Moving the focusing lens 535 causes the focal plane 565 of the focusing lens to move and correspondingly causes movement of the speckle pattern generated in the focal plane by the coherent light beam. This movement of the speckle pattern may be detected by the receiver 510 and averaged in the time domain, or filtered in the frequency domain, to reduce the speckle noise in the signal. The averaging or filtering may be performed by the receiver 510 or by another suitable device.

The mechanism for generating the speckle motion is similar to motion utilized in holography, for example, where motion of a recording film changes the position of the bright and dark fringes.

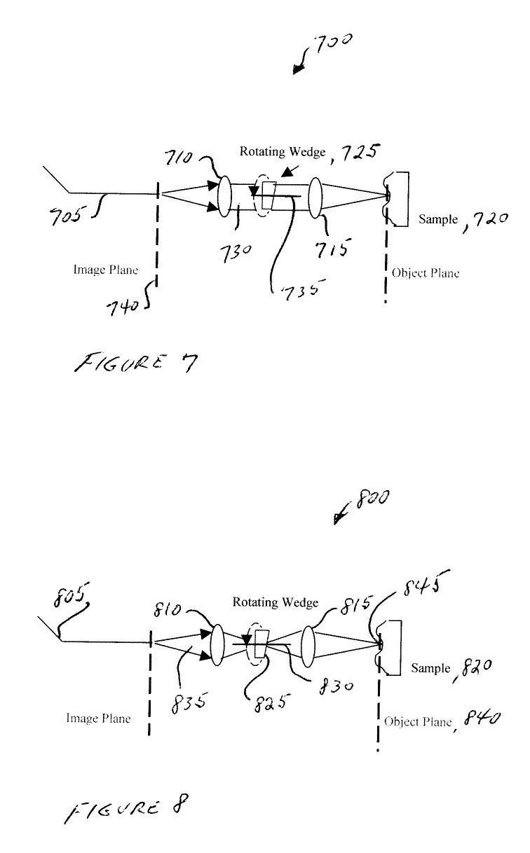

FIG. 6 shows another exemplary embodiment that utilizes a moving lens to convert stationary speckle noise to temporal noise. FIG. 6 shows an OCT system 600 similar to system 500 that includes a broad band light source 605, a receiver 610, a reference arm 615, a sample arm 620, and a 50:50 splitter 625 at a connection among the broad band light source 605, receiver 610, reference arm 615, and sample arm 620. A scanning mechanism 660 similar to scanning mechanisms 250, 350, 450 is included in the reference arm 615 and a fiber path 630 connects the components 605, 610, 615, 620 of the OCT system 600.

In this embodiment, the sample arm 620 includes a collimating lens 635 and a movable focusing lens 640 positioned in the parallel sample illuminating beam 655 generated by the collimating lens 635. The movable focusing lens 640 is generally transported along an axis 650 parallel to beam 655 by any suitable mechanism, including for example, a motor, mechanical drive, electrical drive, magnetic drive, or any other suitable mechanism for transporting the focusing lens 640 along the axis 650. In this sample arm embodiment, movement of the focusing lens 640 corresponds to movement of the focusing lens focal plane 660, allowing for a more efficient speckle modulation.

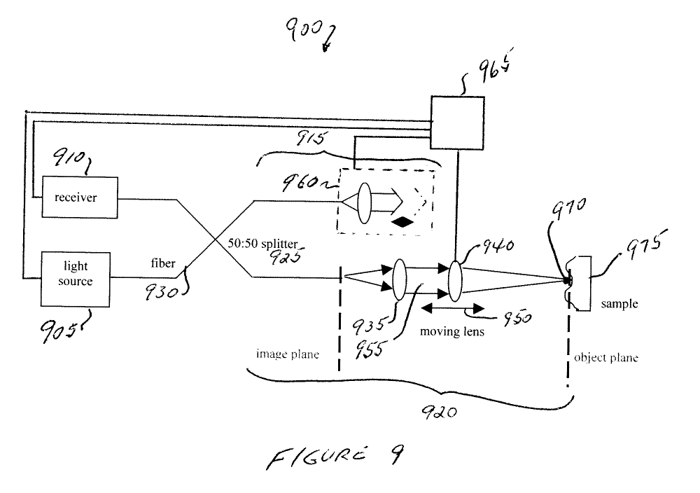

FIGS. 7 and 8 show additional exemplary embodiments of sample arms 700, 800 for use with the fiber based interferometric systems described herein.

In FIG. 7, the sample arm 700 includes a sample portion 705 of a fiber path of the interferometric system, a collimating lens 710, a focusing lens 715, a sample 720, and a rotating transparent wedge 725 interposed between the collimating lens 710 and the focusing lens 715. In this embodiment, light is delivered from the sample portion 705 of a fiber path to the collimating lens which converts the light to a parallel beam. The rotating transparent wedge 725 is positioned in the parallel beam 730 and adds a phase gradient which is focused on sample 720 by focusing lens 715. Similar to other embodiments, the rotating wedge 725 may be rotated around an axis 735 of the parallel beam 730 by any suitable mechanism. Back scattered light from sample 720, that is, the reflected sample beam, may be collected and collimated by focusing lens 715 and passed back through the rotating wedge 725 to the sample portion 705 of the fiber path. Rotation of the wedge 725 modulates the optical phase of the beam 730 and generates motion of the speckle field in the image plane 740. The sample portion 705 of the fiber path conveys the modulated light to the receiver 510, 610. The receiver 510, 610, or another device may then average the resulting signal over time to reduce the speckle noise.

It should be noted that the embodiment of FIG. 7 provides an equivalent to spatial compounding where a sample may viewed from different angles to distinguish speckle noise. For example, in an application where the sample is tissue, an illuminating light beam may scan the tissue surface to perform an axial scan, referred to as an a-scan, where the different parts of a single a-scan reflect the tissue structure of the sample being imaged, thus providing an effective method for spatial averaging and speckle reduction.

In FIG. 8, the sample arm 800 includes a sample portion 805 of a fiber path of the interferometric system, a first focusing lens 810, a second focusing lens 815, a sample 820, and a rotating transparent wedge 825 located between the first 810 and second 815 focusing lenses. As in other embodiments, the rotating wedge 825 may be rotated around an axis 830 of the sample beam 835 by any suitable mechanism. Rotation of the wedge 725 modulates the optical phase of the beam 835, however, in this embodiment, the beam in the object plane 840 does not change a position of an imaged point 845 but scans a range of angles. This embodiment may provide higher transverse resolution than other embodiments.

The rotating wedge 725, 825 of the embodiments of FIGS. 7 and 8 may be replaced with a parallel plate and may operate similar to the embodiment of FIG. 4.

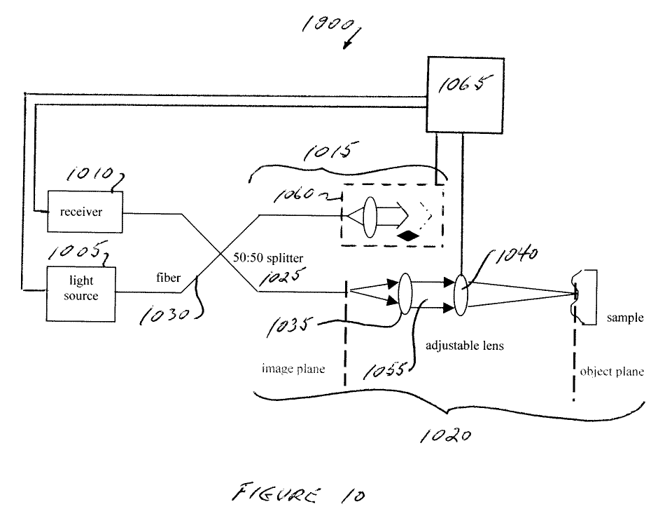

FIG. 9 shows an OCT system that dithers a lens to decorrelate a speckle pattern from an image pattern. In high speed OCT systems, where acquisition time may be very short, the present embodiments may include a method based on the use of a single a-scan for each transverse image coordinate. Speckle noise may be reduced in acquired OCT images by decorrelation of the speckle pattern while leaving the image pattern unaffected. Decorrelation may randomize the effect of speckle from one axial scan (a-scan) to its neighbor across an entire image. When the image is viewed, the features of an observed sample may remain unaffected, while the speckle pattern may be transformed, for example, into a uniform background. The decorrelation may be implemented by modulating a numerical aperture of a sample beam, for example, by dithering a focusing lens.

Turning again to FIG. 9, an OCT system 900 includes a broad band light source 905, a receiver 910, a reference arm 915, a sample arm 920, and a 50:50 splitter 925 at a connection among the broad band light source 905, receiver 910, reference arm 915, sample arm 920, and sample 975. A scanning mechanism 960 similar to scanning mechanisms 560, 660 is included in the reference arm 915 and a fiber path 930 connects the OCT system components 905, 910, 915, 920.

The sample arm 920 includes a collimating lens 935 and a movable focusing lens 940 positioned in the parallel sample beam 955 generated by the collimating lens 935. The movable focusing lens 940 is generally transported along an axis 950 parallel to sample beam 955 by any suitable mechanism. A controller 665 may be used to control the operation of the OCT system 900 and in particular may control the light source 905, the receiver 910, the scanning mechanism 960 and the moving lens 940.

In this embodiment, the controller may cause a dithering of lens 940 which modulates the numerical aperture of the sample beam 955 by dithering the location of a focal point 970 of the lens 940. An OCT image is generally composed of concatenated a-scans. The controller 965 may control the light source 905, the receiver 910, the scanning mechanism 960 and the moving lens 940 so that a number of a-scans may be acquired at different positions while dithering lens 940. At each position of the lens 940 the speckle noise pattern may be different and thus decorrelated from the previous a-scan. The range of motion of the lens 940 may be selected to have a minimal effect on image resolution and on the sample arm length of the OCT system 900. For example, limiting the range of motion to approximately less than 10% of the focal length may have a negligible effect on image resolution and sample arm length. However, dithering the lens 940 may significantly change the speckle pattern which is caused by the randomness of wave phasing. Other lenses in the optical path may also be dithered

Multiple a-scans may be concatenated to generate a two dimensional image. The features of the imaged sample may generally be unaffected by the lens dither. On the other hand, the speckle noise is generally decorrelated (i.e. randomized) from one a-scan to its neighbor. For example, a bit map image of concatenated a-scans may be is displayed with a-scans separated by a distance less than a resolution perceivable by a human eye, the eye may average the speckle pattern so that it appears as a uniform background, for example, having a gray color.

FIG. 10 shows a system for decorrelating speckle noise by modulating the numerical aperture of a sample beam by modulating a focal length of a focusing lens. Similar to the other disclosed OCT systems, the OCT system 1000 of FIG. 10 includes a broad band light source 1005, a receiver 1010, a reference arm 1015, a sample arm 1020, and a 50:50 splitter 1025 at a connection among the broad band light source 1005, receiver 1010, reference arm 1015, and sample arm 1020. A scanning mechanism 1060 similar to scanning mechanisms 560, 660, 960 is included in the reference arm 1015 and a fiber path 1030 connects the OCT system components 1005, 1010, 1015, 1020.

In this embodiment, the sample arm 1020 includes a collimating lens 1035 and a lens 1040 with an adjustable focal length, positioned in the parallel sample beam 1055 generated by the collimating lens 1035. The focal length of lens 1040 may be adjustable by any suitable mechanism. For example, lens 1040 may be constructed with a liquid core within a flexible envelope. Pressure applied to the envelope may change the lens shape and modify the focal length. Alternatively, the focal length can be changed by changing the refractive index of the lens material, for example by applying an acoustic wave to the lens to generate a pressure pattern within the lens that modifies the refractive index of the lens.

Controller 1065 may control the operation of the OCT system 1000 similar to the embodiment shown in FIG. 9, and may also control the mechanism for adjusting the focal length of lens 1040.

Thus, the disclosed embodiments generally operate to convert the stationary patterns of speckle noise to temporal noise which may then be removed by averaging, filtering, etc. In other embodiments, speckle noise reduction may be accomplished by decorrelating the speckle noise across a plurality of scans. Exemplary embodiments include coherent non-interferometric systems and free space and fiber based OCT systems.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method for reducing speckle noise in a coherent imaging system comprising:
applying a time varying phase gradient across a sample beam of the system to convert spatial distortion to temporal noise;
recording a plurality of measurements of the sample beam; and
averaging the plurality of measurements to reduce the temporal noise.

2. The method of claim 1, wherein the sample beam includes a sample illuminating beam.

3. The method of claim 1, wherein the sample beam includes a reflected sample beam.

4. The method of claim 1, wherein the sample beam includes a sample image forming beam.

5. The method of claim 1, wherein the sample beam includes a sample illuminating beam, a reflected sample beam, and a sample image forming beam.

6. The method of claim 1, further comprising utilizing a rotating transparent wedge to apply the time varying phase gradient.

7. The method of claim 1, further comprising utilizing a tilted rotating parallel plate to apply the time varying phase gradient.

8. The method of claim 1, further comprising utilizing a rotating arbitrary index profile plate to apply the time varying phase gradient.

9. The method of claim 1, wherein the coherent system comprises a free space interferometric optical coherence tomography system.

10. The method of claim 1, wherein the coherent system comprises a fiber based interferometric optical coherence tomography system.

11. An apparatus for reducing speckle noise in a coherent imaging system comprising:
an optical element for applying a time varying phase gradient across a sample beam of the system to convert spatial distortion to temporal noise;
a detector for recording a plurality of measurements of the sample beam; and
circuitry for averaging the plurality of measurements to reduce the temporal noise.

12. The apparatus of claim 11, wherein the sample beam includes a sample illuminating beam.

13. The apparatus of claim 11, wherein the sample beam includes a reflected sample beam.

14. The apparatus of claim 11, wherein the sample beam includes a sample image forming beam.

15. The apparatus of claim 11, wherein the sample beam includes a sample illuminating beam, a reflected sample beam, and a sample image forming beam.

16. The apparatus of claim 11, wherein the optical element comprises a rotating transparent wedge.

17. The apparatus of claim 11, wherein the optical element comprises a tilted rotating parallel plate.

18. The apparatus of claim 11, wherein the optical element comprises a rotating arbitrary index profile plate.

19. The apparatus of claim 11, wherein the coherent system comprises a free space interferometric optical coherence tomography system.

20. The apparatus of claim 11, wherein the coherent system comprises a fiber based interferometric optical coherence tomography system.

21. A method for reducing speckle noise in a coherent imaging system comprising:
acquiring a plurality of sample scans while modulating a numerical aperture of a sample beam; and
concatenating the plurality of scans such that speckle noise is decorrelated from adjacent scans of the plurality of scans.
